(19) United States
(12) Patent Application Publication
(10) Pub. No.: US 2020/0338768 A1
(43) Pub. Date: Oct. 29, 2020

(54) TRAVEL RAZOR

(71) Applicant: Roshunda Dixon, Alpharetta, GA (US)

(72) Inventor: Roshunda Dixon, Alpharetta, GA (US)

(21) Appl. No.: 16/853,422

(22) Filed: Apr. 20, 2020

Related U.S. Application Data
(60) Provisional application No. 62/837,459, filed on Apr. 23, 2019.

(51) Int. Cl. B26B 21/40; B26B 21/52

(52) U.S. Cl. CPC B26B 21/4037; B26B 21/522; B26B 21/523

(57) ABSTRACT

The present invention relates to a travel razor having a main body, a first opening protruding into the front side of the main body and a first connection assembly joined to the first opening. Next, a rotating arm having at least one blade, is optionally rotated into the first opening when not in use. The rotating arm further comprises a second connection assembly configured to join the first connection assembly. The rotation of the rotating arm is driven by a spring member joined to the first connection assembly and the main body. Control of the rotation is accomplished by at least one main body button, wherein at least one main body button controls the rotation of the rotating arm. At least one head button assists the user when needing to change, replace or clean at least one blade of the travel razor.

### CROSS-REFERENCE TO RELATED APPLICATIONS

The present invention claims priority to U.S. Provisional Application 62/837,459 filed Apr. 23, 2020, which is hereby incorporated in its entirety at least by reference.

### BACKGROUND

### 1. Field of the Invention

The present invention relates to a travel razor for easy collapsible storage when not in use.

### 2. Description of Related Art

Traditionally when not in use by the user, shaving razors are stored within a storage cover. The storage cover commonly protects a blade of the shaving razor from coming in contact with undesired surfaces and consequentially dulling the blade. It is almost always optimal to keep the blade of a razor as sharp as possible, as a dull blade may result in harming the skin of the user. Problems arise when the user misplaces the storage cover of the razor. There is commonly no apparatus adjoining the storage cover to the body of the razor. Commonly most shaving razors that are available for commercial purchase only come with one storage cover and are not sold individually. Once the cover is lost or misplaced, the user commonly has no way of protecting the razor.

Furthermore, protecting the blades of a razor becomes even more difficult when the user is traveling. Commonly razors are thrown into suitcases and bags along with other bathroom amenities of the user to use during the course of travel. Commonly the storage cover of the razor is pushed or pried off from a resting position where the storage cover is covering the blade of the razor. When storage covers are lost it is common for the user to prematurely dispose of a detachable blade before the blade is dull. The user does so in knowing that the blade will become damaged in travel. A solution is needed for easy protection of and quick access to a blade of a razor when traveling or at home.

### SUMMARY

The present invention solves the problems presented above by presenting a travel razor having a main body configured to be manipulating by the hand of a human user. The main body comprises a first opening protruding into the main body to store the rotating arm of the travel razor when not in use. In doing so, the travel razor prolongs the life of at least one blade of the travel razor and gives the user faster access to at least one blade of the travel razor. Since the main body of the travel razor is adjoined to the rotating arm of the travel razor, it is physically impossible for the user to misplace the main body without physically breaking the travel razor. This directly gives the user peace of mind an improved experience using the travel razor with sharper blades for a prolonged period of time.

One object of the present invention is to provide an improved external grip for easily manipulating the main body of the travel razor. The circular and sleek design of the travel razor allows the user to use at least one finger to grip the main body with more force and control than a traditional hand-held razor.

Another object of the present invention is to provide for safe and secure traveling through airports and airport security. This is accomplished by the design of the travel razor to meet airport travel guidelines.

Another object of the current invention is to provide a rotating arm having at least one head button, wherein at least one head button allows the user access within the rotating arm to clean at least one blade.

Another object of the present invention is to prevent the loss of razor storage covers unnecessarily. The main body of the present invention serves as a handle for the user to grab and a cover to protect the blade of the razor.

In order to do so, a travel razor is provided having a main body, a first opening protruding into the front side of the main body and a first connection assembly joined to the first opening. Next, a rotating arm having at least one blade, is optionally rotated into the first opening when not in use. The rotating arm further comprises a second connection assembly configured to join the first connection assembly. The rotation of the rotating arm is driven by a spring member joined to the first connection assembly and the main body. Control of this rotation is accomplished by at least one main body button, wherein at least one main body button controls the rotation of the rotating arm. When the user needs to change, replace or clean at least one blade of the travel razor at least one head button allows the at least one blade to be removed from the rotating arm.

### BRIEF DESCRIPTION OF THE FIGURES

The detailed description of some embodiments of the invention is made below with reference to the accompanying figures, wherein like numerals represent corresponding parts of the figures.

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an exemplary isometric view of one embodiment of the travel razor.

FIG. 2 shows an exemplary isometric view of one embodiment of the travel razor.

FIG. 3 shows an exemplary exploded view of one embodiment of the travel razor.

FIG. 4 shows an exemplary front view of one embodiment of the travel razor.

FIG. 5 shows an exemplary right view of one embodiment of the travel razor.

FIG. 6 shows an exemplary rear isometric view of one embodiment of the travel razor.

FIG. 7 shows an exemplary bottom view of one embodiment of the travel razor.

FIG. 8 shows an exemplary top view of one embodiment of the travel razor.

### DETAILED DESCRIPTION OF CERTAIN EMBODIMENTS

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

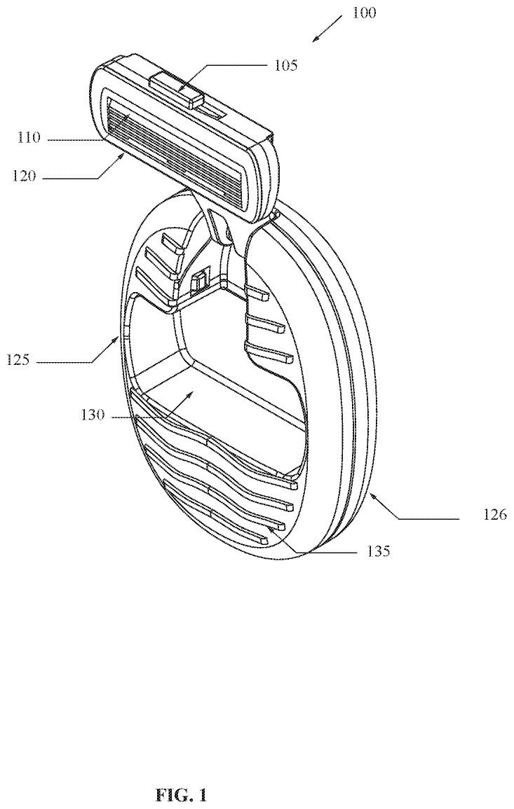

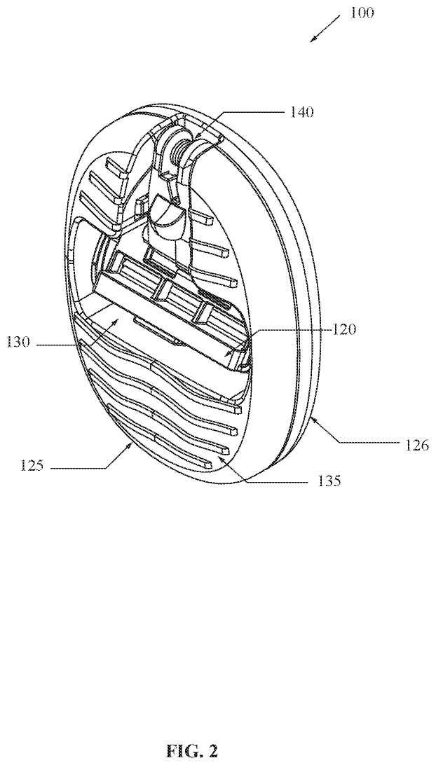

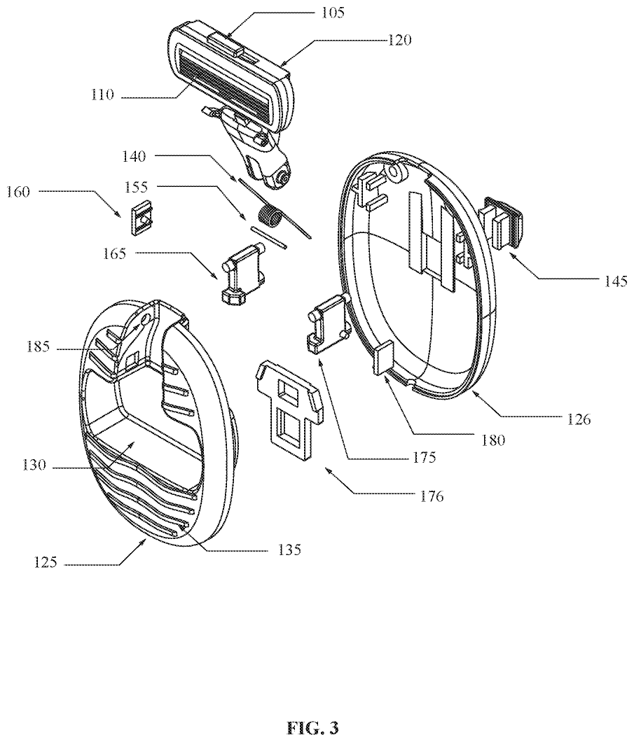

FIGS. 1-2 illustrates an exemplary embodiment a travel razor 100 from a perspective view. The travel razor 100 is deployed or moved from a storage position (as shown in FIG. 2) to an open position (as shown in FIG. 1). FIG. 3 illustrates an exemplary exploded view of the travel razor 100. The travel razor 100 having a main body having a main body front side 125 and a main body rear side 126.

In some embodiments, the main body front side 125 and the main body rear side 126 further comprise a first external texture 135 and a second external texture 136, respectively. In some embodiments, the first external texture 135 and the second external texture 136 further comprises at least one member of a texture set consisting of: indentations, extrusions, knurling, a rough surface, and bumps. Located on the main body front side 125 a first opening 130 protrudes into the main body front side 125. The first opening 130 has a closed back portion and is only open on the font side 125 of the main body. The travel razor 100 has a rotating arm 120 having a blade razor head 110 comprising at least one blade, wherein the rotating arm 120 moves by rotation into the first opening 130 when not in use and when the user desires to configure the travel razor 100 to the storage position, wherein the rotating arm 120 and blade razor head is configured to be positioned in the first opening during storage. In other embodiments, at least one blade may articulate about the rotating arm 120. As shown in FIGS. 1-2, the blade razor head 110 is shown in an exemplary configuration having a flat blade edge. In other embodiments, the at least one blade in the blade razor head 110 may be configured to comprise a convex edge blade, a concave blade edge, a wavy blade edge, a serrated blade edge or any other blade edge shape known to one skilled in the art for shaving human hair. The main body front side 125 holds and protections the rotating arm 120 when the travel razor 100 is not in use by the user.

To accomplish the rotation of the rotating arm 120 to the open position and the closed position, in some embodiments, a first connection assembly is joined to the first opening 130. In some embodiments, the first connection assembly comprises a first axle 155. In some embodiments, the rotating arm 120 rotates from the storage position to the open position about the first axle 155. In some embodiments, the main body front side 125 and the main body rear side 126 further comprise a first circular indentation 185, wherein the first circular indentation 185 is configured to receive the first axle 155.

Next, in some embodiments, the rotating arm 120 further comprises a second connection assembly configured to join the first connection assembly. The second connection includes a first tab 160, a second tab 180, a third tab 165, a fourth tab 175 and a fifth tab 176. The fifth tab 176 is directly adjoined to at least one main body button 145, wherein at least one main body button 145 controls the release of the rotating arm 120 from a storage position by moving the fifth tab 176 in a linear motion. The linear motion of the fifth tab 176, therein moving the third tab 165 and the fourth tab 175 and allowing a spring member 140 joined to the first connection assembly and the main body to move the rotating arm 120 from the storage position to the open position. In some embodiments, the spring member 140 is positioned around the first axle 155.

In some embodiments, at least one secondary spring member (not shown) is positioned between the first tab 160 and the third tab 165 and between the fourth tab 175 and the second tab 180. When the user is done with the travel razor 100 the rotating arm 120 is pushed back against the third tab 165 and the fourth tab 175, in doing so, at least one secondary spring member is compressed and the third tab 165 and the fourth hold the rotating arm 120 in the storage position.

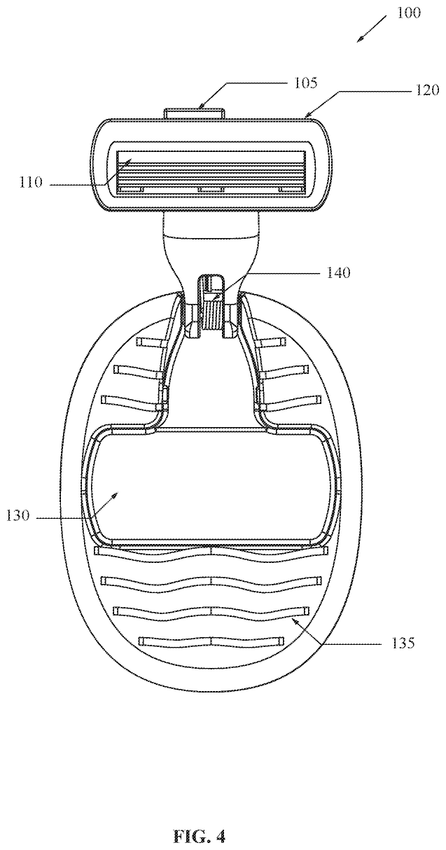

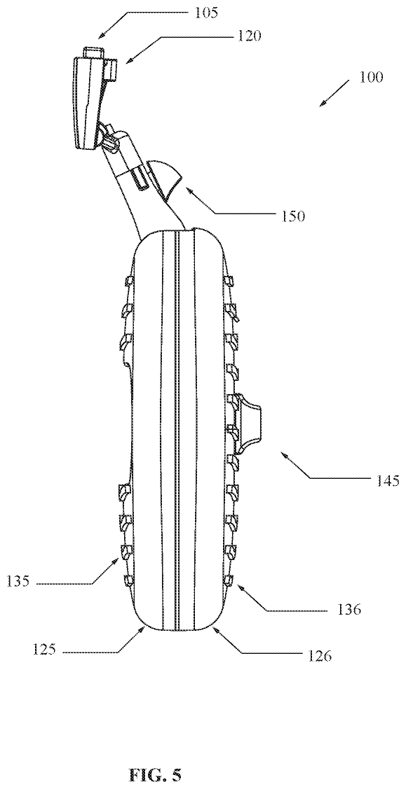

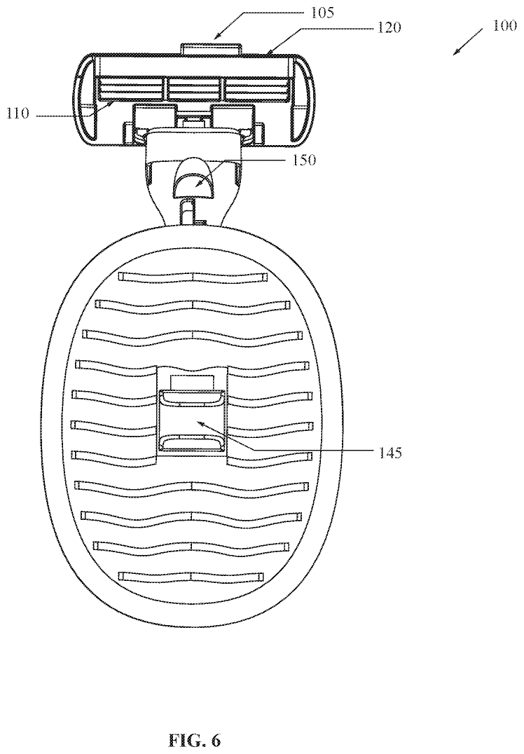

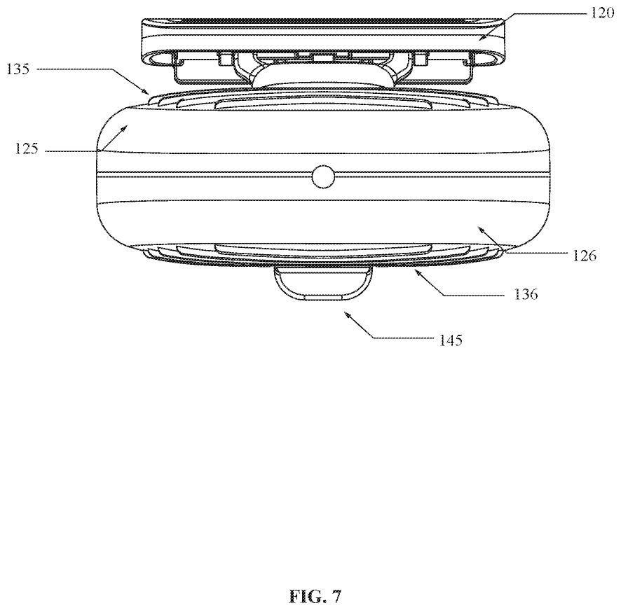

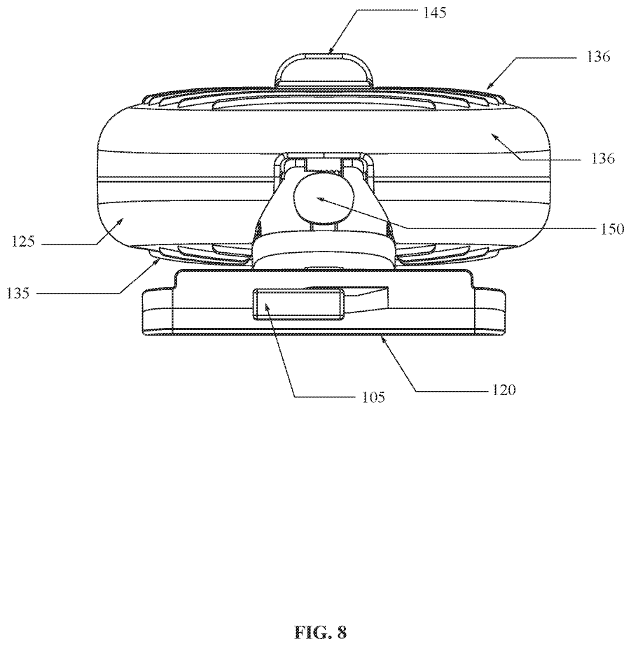

As shown in FIGS. 4-8, in some embodiments, the rotating arm 120 of the travel razor 100 further comprises at least one release button 150, wherein the at least one release button 150 allows the blade razor head 110 comprising at least one blade to be removed from the rotating arm 120. In some embodiments, at least one head button 105 allows the user access within the rotating arm 120 to clean or replace the blade razor head. In some embodiments, the at least one main body button 145 and the at least one release button 150 are configured and shaped to receive at least one finger of a human hand. In some embodiments, the at least one release button 150 is located on a top side of the rotating arm 120. In some embodiments, the at least one release button 150 is located on any side of the rotating arm 120. In some embodiments, the first connection assembly and the second connection assembly are at least one member of a connection set consisting of: a magnet, a clip, a heat-shrink material flange, a slide-fit, a rubber grommet, a clamp, a spring, a fastener, an elastic member, and an adhesive. In some embodiments, the main body front side 125 is adjoined to the main body rear side 126 by at least one member of the connection set. In exemplary use, by way of non-limiting example, at least one head button 150 and/or at least one main body button 145 can be moved by pushing, pulling, squeezing, sliding, twisting or any combination thereof.

In some embodiments, the travel razor 100 is made of at least one material of a materials set, by way of non-limiting example, consisting of: a metal, a rubber, a carbon fiber, a composite material, a ceramic material, a plastic, a wood, a foam, and a fabric. In some embodiments the rotating arm 120 or the main body of the travel razor 100 further comprises at least one member of an identification set consisting of: an alphanumeric identification, a human user's name, a symbolic shape, a company brand, a numeric identification number, a QR code, a barcode, and an RFID tag. In some embodiments, at least one member of the identification set is used to covey to the user the type of razor, the brand of the razor or the any other information known to one skilled in the art to convey a characteristic of a commercially available razor.

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by about 0%, 5%, or 10%, including increments therein.

Unless otherwise defined, all technical terms used herein have the same meaning as commonly understood by one of ordinary skill in the art to which this disclosure belongs.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, ¶6. In particular, any use of “step of” in the claims is not intended to invoke the provision of 35 U.S.C. § 112, ¶6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A travel razor comprising:
a main body having a storage cavity;
a rotating arm configured to hold a blade razor head having at least one blade, wherein the rotating arm and the attached blade razor head is configured to be releasably positioned in the storage cavity such that the rotating arm is movable between a storage position and an opened position;
a first button configured to release the rotating arm from the storage position; and,
a second button configured to release the blade razor head from the rotating arm.

2. The travel razor of claim 1, further comprising a third button configured to open the blade razor head to access the at least one blade for cleaning.

3. The travel razor of claim 1, wherein the main body comprises an external texture to aid in gripping the travel razor.

4. The travel razor of claim 1, wherein the rotating arm is configured to be biased in the opening position via a spring member.

5. The travel razor of claim 1, wherein the rotating arm is configured to be locked in the storage position via a tab member.

6. A travel razor, configured to be manipulated by a human user of the travel razor,
the travel razor comprising:
a main body having a main body front side and a main body rear side and having a first opening protruding into the main body front side;
a first connection assembly joined to the first opening;
a rotating arm having at least one blade, wherein the rotating arm moves by rotation into the first opening, wherein the rotating arm further comprises a second connection assembly configured to join the first connection assembly;
a spring member joined to the first connection assembly and the main body;
at least one main body button, wherein at least one main body button controls the rotation of the rotating arm; and
at least one head button, wherein the at least one head button allows the at least one blade to be removed from the rotating arm.
